(19) United States
(12) Patent Application Publication
(10) Pub. No.: US 2015/0242429 A1
(43) Pub. Date: Aug. 27, 2015

(54) DATA MATCHING BASED ON HASH TABLE REPRESENTATIONS OF HASH TABLES

(71) Applicant: Alcatel Lucent, Paris (FR)

(72) Inventors: Matteo Varvello, Middletown, NJ (US); Diego Perino, Issy-les-Moulineaux (FR)

(73) Assignee: Alcatel Lucent, Paris (FR)

(21) Appl. No.: 14/189,119

(22) Filed: Feb. 25, 2014

(51) Int. Cl. G06F 17/30

(52) U.S. Cl. CPC G06F 17/30109; G06F 17/3033; G06F 17/3053; G06F 17/30864

(57) ABSTRACT

A data matching capability is presented herein. The data matching capability may be configured to support matching of a set of values of a set of data fields to a corresponding set of values of a corresponding set of data fields. The data matching capability may be configured to support matching of a set of values of a set of data fields to a corresponding set of values of a corresponding set of data fields based on use of the set of values of the set of data fields as an input and based on a hash table representation of a hash table storing the corresponding set of values of the corresponding set of data fields. The data matching capability may be used within various contexts including packet classification within telecommunication networks.

### TECHNICAL FIELD

The disclosure relates generally to data matching and, more specifically but not exclusively, to data matching based on hash table representations of hash tables.

### BACKGROUND

Data matching is used in a wide variety of contexts and for a wide variety of purposes. For example, data matching may be used in applied statistics, data management, data mining, machine learning, artificial intelligence, database management, healthcare applications, communication applications, and the like. Within communications environments, for example, data matching may be used for packet classification, address lookups, flow control, or various other types of functions performed within various types of communication environments.

Packet classification is generally performed by matching a tuple, or set, of header fields of incoming packets against a set of candidate packet classification rules in order to determine proper handling of each packet (e.g., performing a particular type of processing on the packet, forwarding the packet to a given next hop, dropping the packet, or the like). In many cases, packet classification needs to be performed across communication layers (e.g., layers (Ls) of the Open Systems Interconnection (OSI) model) based on information from multiple communication layers. This is often referred to as multi-layer packet classification. For example, several types of network equipment implement multi-layer packet classification which may operate on fields from the physical, network, and transport layers, such as firewalls (e.g., operating on L2-L4 of the OSI model), network address translators (e.g., operating on L3-L4 of the OSI model, virtual switches in software defined networks (e.g., operating on L2-L4 of the OSI model), and so forth.

Many packet classification schemes are currently implemented via specialized hardware, such as ternary content-addressable memory (TCAM), in order to satisfy strict speed requirements. However, the availability of powerful commodity hardware, coupled with the high cost, limited storage, and high power consumption of TCAM, have sparked new interest in fast software-based packet classification. Additionally, recent developments in virtualized environments (e.g., multi-tenant networks, network function virtualization, and the like) have resulted in widespread adoption of virtual switches, which typically include software programs that classify packets. However, many virtualized environments are operating at speeds that require throughputs of 10 Gbps or greater in order to avoid bottlenecks and delays, such that software-based packet classification speeds need to be improved in order to support such throughput requirements. Additionally, the recent emergence of software defined networking (SDN), which has a strong emphasis on rule-based packet processing and flow classification, also is driving a need for faster software-based packet classification. For example, in SDN that is based on OpenFlow, the relatively large rule tables and the relatively long multi-dimensional OpenFlow tuples may impose unforeseen challenges for current software-based packet classifiers that cannot be easily addressed by hardware-based packet classification schemes.

Accordingly, in view of these and various other developments related to use of software-based packet classification schemes and software-based packet classification in general, there is a renewed interest in and need for improved software-based packet classification schemes.

### SUMMARY OF EMBODIMENTS

Various deficiencies in the prior art are addressed by embodiments for performing data matching based on hash table representations.

In at least some embodiments, an apparatus is configured to match data using a set of hash functions. The apparatus includes a processor and a memory communicatively connected to the processor. The processor is configured to receive a data set including a set of data fields having a respective set of data values associated therewith. The processor is configured to compute, for each of the hash functions, a respective set of hash values for the data set by hashing each of the data values of the data set using the respective hash function. The processor is configured to compute a set of hash bits for the data set based on the respective sets of hash values for the data set. The processor is configured to determine whether a hash table potentially includes a match for the data set by checking a hash table representation of the hash table based on the set of hash bits for the data set.

In at least some embodiments, a method includes using a processor and a memory for matching data using a set of hash functions. The method includes receiving a data set including a set of data fields having a respective set of data values associated therewith. The method includes computing, for each of the hash functions, a respective set of hash values for the data set by hashing each of the data values of the data set using the respective hash function. The method includes computing a set of hash bits for the data set based on the respective sets of hash values for the data set. The method includes determining whether a hash table potentially includes a match for the data set by checking a hash table representation of the hash table based on the set of hash bits for the data set.

In at least some embodiments, a computer-readable storage medium stores instructions which, when executed by a computer, cause the computer to perform a method for matching data using a set of hash functions. The method includes computing, for each of the hash functions, a respective set of hash values for the data set by hashing each of the data values of the data set using the respective hash function. The method includes computing a set of hash bits for the data set based on the respective sets of hash values for the data set. The method includes determining whether a hash table potentially includes a match for the data set by checking a hash table representation of the hash table based on the set of hash bits for the data set.

In at least some embodiments, an apparatus is configured to classify data using a set of data classification rules and a set of hash functions. The apparatus includes a processor and a memory communicatively connected to the processor. The processor is configured to receive a tuple including a set of tuple fields having a respective set of data values associated therewith, mask the set of data values of the set of tuple fields of the tuple to form a masked tuple, compute a set of hash values for the tuple based on hashing of the masked tuple using the respective hash functions, and determine whether a hash table potentially includes a data classification rule matching the tuple by checking a hash table representation of the hash table based on the set of hash values for the tuple.

### BRIEF DESCRIPTION OF THE DRAWINGS

The teachings herein can be readily understood by considering the detailed description in conjunction with the accompanying drawings, in which:

FIG. 1 depicts an exemplary communication system including a packet classification element configured to perform packet classification;

FIG. 2 depicts one embodiment of a method for performing insertion of a new packet classification rule within the packet classification element of FIG. 1;

FIG. 3 depicts one embodiment of a method for performing a lookup for a tuple of a packet at the packet classification element of FIG. 1;

FIG. 4 depicts one embodiment of a method for performing insertion of a new packet classification rule within the packet classification element of FIG. 1;

FIG. 5 depicts one embodiment of a method for performing a lookup for a tuple of a packet at the packet classification element of FIG. 1;

FIG. 6 depicts an exemplary set of packet classification rules for illustrating relationships between the packet classification rules and rule classes, hash table representations, and hash tables of the packet classification element of FIG. 1; and

FIG. 7 depicts a high-level block diagram of a computer suitable for use in performing functions presented herein.

To facilitate understanding, identical reference numerals have been used, where possible, to designate identical elements common to the figures.

### DETAILED DESCRIPTION OF EMBODIMENTS

A data matching capability is presented herein. The data matching capability may be configured to support matching of a set of values of a set of data fields to a corresponding set of values of a corresponding set of data fields. The data matching capability may be configured to support matching of a set of values of a set of data fields to a corresponding set of values of a corresponding set of data fields based on use of the set of values of the set of data fields as an input and based on a hash table representation of a hash table storing the corresponding set of values of the corresponding set of data fields. The data matching capability may be used within various contexts including, but not limited to, applied statistics, data management, data mining, machine learning, artificial intelligence, database management, healthcare applications, communication applications, or any other suitable environments or applications for data matching, as well as various combinations thereof. However, for purposes of clarity in describing various embodiments of the data matching capability, the data matching capability is primarily depicted and described herein within the context of performing data matching for data classification within a communication environment and, more specifically, for classification of data packets within a communication environment (referred to herein as a data classification capability). Accordingly, it will be appreciated that various references herein to data classification capabilities may be read more generally as being data matching capabilities, data lookup capabilities, or any other related or suitable types of capabilities.

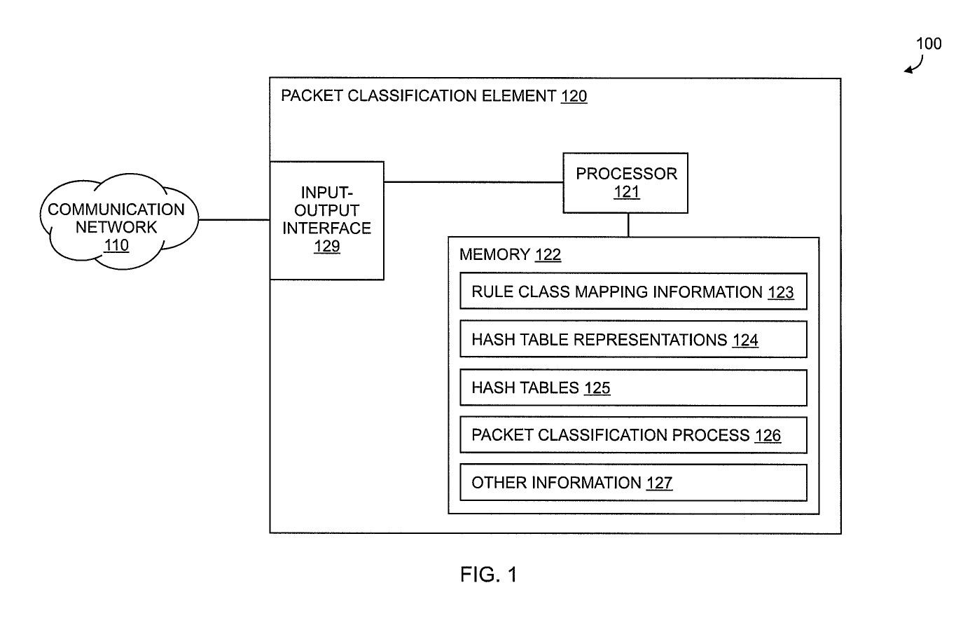

As noted above, a data classification capability is presented herein. The data classification capability may support classification of data items based on a set of data classification rules. For example, the data classification capability may be used for classification of packets based on packet classification rules (e.g., for identification and application of actions to packets), classification of packet flows based on flow classification rules (e.g., for identification and application of flow routing to packet flows), or the like. However, for purposes of clarity, embodiments of the data classification capability are primarily depicted and described within the context of packet classification based on packet classification rules. In at least some embodiments, the data classification capability supports classification of a tuple of a data item based on organization of data classification rules into rule classes, where the rule classes have associated therewith respective hash tables storing respective subsets of the data classification rules and respective hash table representations providing relatively compact representations of the respective hash tables for improved tuple matching efficiency. Various embodiments of the data classification capability may be adapted for use in various types of data classification elements. Various embodiments of the data classification capability may be particularly well suited for use in highly parallelized architectures (e.g., using multiple processing units, using network processors, or the like). These and various other embodiments of the data classification capability, and the more general data matching capability, may be better understood by way of reference to a packet classification element configured to perform packet classification within a communication network, as depicted in FIG. 1.

FIG. 1 depicts an exemplary communication system including a packet classification element configured to perform packet classification.

The exemplary communication system 100 includes a communication network 110 and a packet classification element 120 that is located within communication network 110.

The communication network 110 may include any suitable type of communication network configured to support transport of packets. The communication network 110 may include any suitable type of communication network in which classification of packets is necessary or desirable. For example, communication network 110 may be a wireless access network, a wireless core network, a wireline access network, a wireline core network, an Enterprise network, a datacenter network, or the like, as well as various combinations thereof.

The packet classification element 120 is configured to receive packets from communication network 110 and to classify the packets. The packet classification element 120 may be implemented in any suitable manner. In at least some embodiments, packet classification element 120 includes a processor 121, a memory 122 that is communicatively connected to the processor 121, and an input-output interface 129 that is communicatively connected to the processor 121. The processor 121 is configured to execute various processes and programs in order to provide various functions as discussed herein. The memory 122 is configured to store various programs, data, and other information which may be used by processor 121 to provide various functions as discussed herein. The input-output interface 129 is configured as an interface to communication network 110 (e.g., for receiving packets from other elements of communication network 110, for propagating packets to other elements of communication network 110, or the like).

The packet classification element 120 is configured to receive packets and classify the packets based on a set of packet classification rules (which also may be referred to herein as a rule set). In general, a tuple may be defined as the set of header fields used for packet classification. In general, a rule may include a value, a mask, an action, and, optionally, a priority. The value of the rule specifies the header fields required in a tuple of a packet for which a match is required, with wildcards allowed. The mask of the rule specifies the position of the wildcarded fields within the value of the rule. The action of the rule specifies the operation or operations to be performed on a packet that includes a tuple matching the rule. The priority of the rule specifies the importance of the rule relative to other rules, and may be used to prioritize rules in cases in which multiple rules match the same tuple of a packet being classified. In general, classification of a tuple of a packet based on a set of packet classification rules includes identifying one or more packet classification rules matching the tuple of the packet (or a highest priority packet classification rule matching the tuple of the packet where rule priorities are used to prioritize amongst the packet classification rules in the set of packet classification rules). The packet classification element 120 also may be configured to apply packet classification rules to packets classified based on the set of packet classification rules (e.g., applying the action(s) of the packet classification rule(s) identified as matching the tuple of the packet during classification of the packet). The packet classification element 120 may be implemented as a standalone network element, as part of an element, or the like. For example, packet classification element may be, or may be implemented as part of, a router, a physical switch, a virtual switch (e.g., in a software defined network), a firewall, a network address translator, or the like, as well as various combinations thereof.

The packet classification element 120 is configured such that the packet classification rules of the set of packet classification rules are classified into a set of rule classes based on the positions of wildcards in the tuples of the packet classification rules, where packet classification rules are members of the same rule class if the tuples of the packet classification rule have wildcards in the same fields. The packet classification element 120 is configured to store rule class mapping information 123 for the set of rule classes, where the rule class mapping information 123 provides, for each rule class, a mapping of that rule class to a class descriptor of that rule class, respectively. The rule class mapping information 123 may be maintained as a class table or using any other suitable type of data structure or arrangement of information. The descriptor for a rule class is a high-level tuple common to each packet classification rule that is classified as part of the rule class. For example, assuming packet classification rules described by 3-tuples in the form of <SRC_IP, DST_IP, SRC_PORT>, a rule <*, 10.0.0.1, 80> may be a member of the rule class having class descriptor <*,32,16>, where DST_IP and SRC_PORT are stored using 32 and 16 bits, respectively. Similarly, for example, assuming packet classification rules described by 5-tuples in the form of <SRC_IP, SRC_PORT, DST_IP, DST_PORT, PROTO>, a rule <*, *, 10.0.0.1, 80, *> may be a member of the rule class having class descriptor <*, *, 32,16, *>, where DST_IP and SRC_PORT are stored using 32 and 16 bits, respectively.

The packet classification element 120 is configured such that the packet classification rules of the set of packet classification rules are stored in a set of hash tables 125₁-125_{M} (collectively, hash tables 125) corresponding to the rule classes defined in rule class mapping information 123. Namely, packet classification rules that are members of the same rule class are stored in the same hash table 125ᵢ. It will be appreciated that, given M rule classes, there will be M hash tables 125. In general, a packet classification rule of rule class i may be stored in hash table 125ᵢ using an entry that includes (1) a hash of the tuple of the packet classification rule as a key into the hash table 125ᵢ and (2) a corresponding value including rule information of the packet classification rule. The rule information for a packet classification rule may include one or more of an action for the packet classification rule, a priority of the packet classification rule, statistics associated with the packet classification rule, or the like, as well as various combinations thereof. The action of a packet classification rule may specify handling of a packet matching the packet classification rule (e.g., forwarding the packet, dropping the packet, performing particular type of processing on the packet, or the like, as well as various combinations thereof. The priority of a packet classification rule may be used to resolve ties when multiple matching packet classification rules are identified for a packet being classified. The statistics of a packet classification rule represent the number of packets identified as matching the packet classification rule. It will be appreciated that other types of rule information may be specified for a packet classification rule.

The packet classification element 120 is configured such that the hash tables 125₁-125_{M} are represented using a set of hash table representations 124₁-124_{M} (collectively, hash table representations 124), respectively. The hash table representations 124₁-124_{M} are configured to provide indications as to which packet classification rules are stored in the hash tables 125₁-125_{M}, respectively, without actually storing the packet classification rules. The hash table representations 124₁-124_{M} are configured to provide indications as to which packet classification rules are stored in the hash tables 125₁-125_{M}, respectively, without false negatives (although it will be appreciated that false positives may be possible). The hash table representation 124ᵢ for a given hash table 125ᵢ may be represented using a set of m hash bits where the presence of different packet classification rules within the hash table 125ᵢ may be represented within hash table representation 124ᵢ using different sets of k hash bits of the m hash bits where the values of the k hash bits are set based on k hash functions associated with the hash table representation 124ᵢ. The hash table representations 124 may be dimensioned for reducing or minimizing false positive probability (e.g., based on selection of the value of k, selection of the hash functions to be used as the k hash functions, based on the selection of the value of m, or the like, as well as various combinations thereof). The hash table representations 124 may be managed by supporting insertions into and deletions from hash table representations 124. It will be appreciated that, while the set of hash tables 125 may be able to be stored on relatively small and fast memory (e.g., SRAM) in certain cases, there are various situations in which the set of hash tables 125 may initially be, or grow to be, too large to be stored on such relatively small and fast memory and, thus, may need to be stored on relatively large and slow memory (e.g., DRAM, RLDRAM, or the like). In such cases, since the hash table representations 124 provide a relatively compact representation of the hash tables 125, the hash table representations 124 may be stored on relatively small and fast memory even when the respective hash tables 125 need to be stored on relatively large and slow memory. In at least some embodiments, the relatively large and slow memory may be the main memory of a primary processing unit (e.g., a Central Processing Unit (CPU) or any other suitable type of primary processing unit), while the relatively small and fast memory may be shared memory of a secondary processing unit (e.g., shared memory of a Graphics Processing Unit (GPU) or any other suitable type of secondary processing unit). The hash table representations 124 may be implemented using any type of data structure suitable for providing a relatively compact representation of the hash tables 125, such as Bloom filters or any other suitable type of data structure. The hash table representations 124 are primarily depicted and described herein within the context of embodiments in which hash table representations 124 are Bloom filters and, thus, also may be referred to herein as Bloom filters 124.

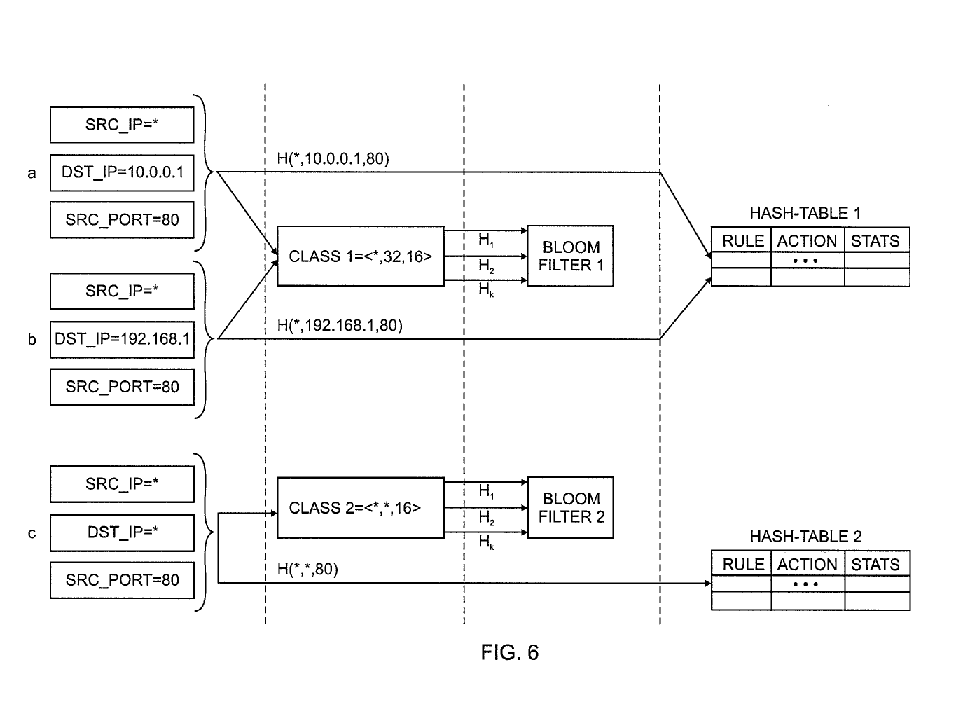

The packet classification element 120 may be configured to provide packet classification functions (e.g., insertions, lookups, or the like) using a packet classification process 126. The packet classification process 126 may be retrieved from memory 122 and executed by processor 121 to provide various packet classification functions. As discussed in additional detail below, the packet classification process 126 may utilize or update one or more of rule class mapping information 123, hash table representations 124, or hash tables 125 to provide packet classification functions. The memory 122 of packet classification element 120 also may store any other information (denoted as other information 127) which may be associated with execution of packet classification process 126 for providing packet classification functions. The relationships between packet classification rules and the rule class mapping information 123, hash table representations 124, and hash tables 125 may be better understood by way of reference to FIG. 6.

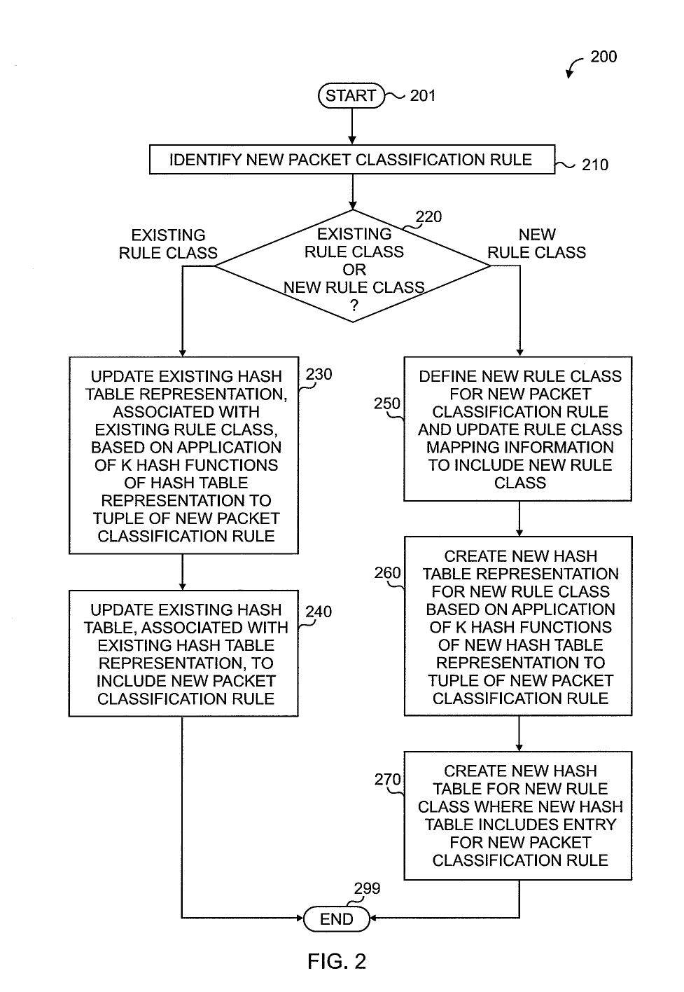

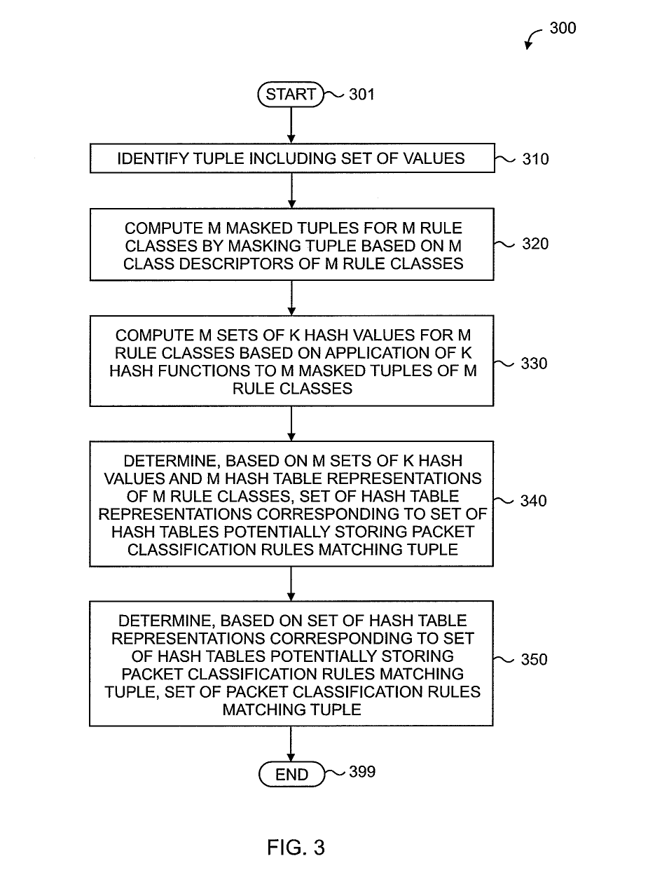

In at least some embodiments, packet classification process 126 is configured to provide packet classification functions based on hashing on tuples of a packet received at packet classification element 120. In at least some embodiments, the packet classification process 126 may be configured to (1) perform insertions of new packet classification rules received at packet classification element 120 using the packet classification rule insertion process depicted in FIG. 2 and (2) perform lookups for tuples of packets received at packet classification element 120 using packet classification rule lookup process depicted in FIG. 3.

FIG. 2 depicts one embodiment of a method for performing insertion of a new packet classification rule within the packet classification element of FIG. 1. It will be appreciated that, although primarily depicted and described as being performed serially, at least a portion of the steps of method 200 may be performed contemporaneously or in a different order than presented in FIG. 2.

At step 201, method 200 begins.

At step 210, a new packet classification rule is identified. The new packet classification rule may be identified based on explicit identification of the new packet classification rule, a failure to identify a matching packet classification rule during a packet classification rule lookup operation, or the like.

At step 220, a determination is made as to whether the new packet classification rule corresponds to an existing rule class or whether a new rule class needs to be created for the new packet classification rule. If a determination is made that the new packet classification rule corresponds to an existing rule class, method 200 proceeds to step 230. If a determination is made that a new rule class needs to be created for the new packet classification rule, method 200 proceeds to step 250. This determination as to whether the new packet classification rule corresponds to an existing rule class or whether a new rule class needs to be created for the new packet classification may be performed by (a) determining a descriptor of the new packet classification rule and (b) searching rule class mapping information (illustratively, rule class mapping information 123) to determine whether the descriptor of the new packet classification rule matches an existing class descriptor of an existing rule class. If the descriptor of the new packet classification rule matches an existing class descriptor of an existing rule class, the new packet classification rule is added to the packet classification element 120 as part of the existing rule class. If the descriptor of the new packet classification rule does not match an existing class descriptor of an existing rule class, the new packet classification rule is added to the packet classification element 120 as part of the new rule class created at the packet classification element 120 for the new packet classification rule.

At step 230, an existing hash table representation (illustratively, a hash table representation 124ᵢ) that is associated with the existing rule class is updated to include a representation of the new packet classification rule. The existing hash table representation may be updated by applying each of the k hash functions associated with the hash table representation to the tuple of the new packet classification rule and setting the corresponding k hash bits of the hash table representation accordingly.

At step 240, an existing hash table (illustratively, a hash table 125ᵢ) that is associated with the existing rule class is updated to include the new packet classification rule. The existing hash table may be updated by creating a new entry for the new packet classification rule. The new entry of the existing hash table for the new packet classification rule may include (1) a hash of the tuple of the new packet classification rule as a key into the new entry of the existing hash table and (2) a corresponding value including rule information of the new packet classification rule (e.g., action, priority, or the like, as well as various combinations thereof). From step 240, method 200 proceeds to step 299, where method 200 ends.

At step 250, a new rule class is defined for the new packet classification rule and the rule class mapping information (illustratively, rule class mapping information 123) is updated to include the new rule class.

At step 260, a new hash table representation (illustratively, a new hash table representation 124ᵢ) is created for the new rule class defined for the new packet classification rule. The new hash table representation may be created for the new rule class by applying each of k hash functions associated with the new hash table representation to the tuple of the new packet classification rule and setting the corresponding k hash bits of the new hash table representation accordingly.

At step 270, a new hash table (illustratively, a new hash table 125ᵢ) is created for the new rule class defined for the new packet classification rule. The new hash table is associated with the new hash table representation. The new hash table for the new rule class may be created by generating the new hash table to include an entry for the new packet classification rule. The entry of the new hash table for the new packet classification rule may include (1) a hash of the tuple of the new packet classification rule as a key into the entry of the new hash table and (2) a corresponding value including rule information of the new packet classification rule (e.g., action, priority, or the like, as well as various combinations thereof). From step 270, method 200 proceeds to step 299, where method 200 ends.

At step 299, method 200 ends.

FIG. 3 depicts one embodiment of a method for performing a lookup for a tuple of a packet at the packet classification element of FIG. 1. The method 300 is configured to perform the lookup for the tuple based on a set of rule classes (illustratively, rule classes as defined in rule class mapping information 123) having respective hash tables (illustratively, hash tables 125) associated therewith, where the hash tables have respective hash table representations (illustratively, hash table representations 124) associated therewith. It will be appreciated that, although primarily depicted and described as being performed serially, at least a portion of the steps of method 300 may be performed contemporaneously or in a different order than presented in FIG. 3.

At step 301, method 300 begins.

At step 310, the tuple (T) of the packet is identified. The tuple T may include a set of values (one or more values) associated with a set of fields (one or more fields) of the tuple T. The set of fields of the tuple T may include one or more wildcarded values.

At step 320, M masked tuples are computed for the M rule classes by masking the tuple T based on the M class descriptors of the M rule classes. For a given rule class, the masking of the tuple T with the class descriptor of the rule class may include performing a field-wise logical AND of the set of values of the tuple T and the set of fields of the class descriptor.

At step 330, M sets of hash values are computed for the M rule classes based on the M masked tuples. For a given rule class and associated hash table representation, the computation of the set of hash functions for the rule class may include computing k hash values by applying k hash functions of the hash table representation to the masked tuple associated with the rule class. In other words, each of the M masked tuples is hashed k times using k hash functions for form M sets of hash values for the M masked tuples (which are associated with the M rule classes and, thus, the M hash table representations, respectively).

At step 340, a set of hash table representations corresponding to a set of hash tables potentially storing packet classification rules matching the tuple T is determined. For each of the M rule classes, a determination is made as to whether the tuple of the packet potentially matches a packet classification rule of the hash table associated with the rule class. For each of the M rule classes, the set of hash values computed for a given rule class is used as a key into the hash table representation of the given rule class. If a match is found in a hash table representation, this is indicative that the associated hash table corresponding to the hash table representation may include a packet classification rule matching tuple T (or may not, given that the hash table representations may suffer from false positives). If a match is not found in a hash table representation, this is indicative that the associated hash table corresponding to the hash table representation does not include a packet classification rule matching tuple T (as there are no false negatives). The results of these M lookup operations may be represented in any suitable format. For example, the results of these M lookup operations may be represented as an M-bit array where the M bit positions of the M-bit array correspond to the M rule classes, and where a given bit position of the M-bit array is set to a first value (e.g., “1”) based on a determination that the set of hash values resulted in identification of a match in the corresponding hash table representation (and, thus, that the associated hash table corresponding to the hash table representation potentially includes a packet classification rule matching tuple T) or set to a second value (e.g., “0”) based on a determination that the set of hash values did not result in identification of a match in the corresponding hash table representation (and, thus, that the associated hash table corresponding to the hash table representation does not include a packet classification rule matching tuple T). The results of the M determinations performed for the M rule classes based on the M sets of hash values may be represented in any other suitable manner.

At step 350, a set of matching packet classification rules is determined for the tuple T based on the set of hash table representations corresponding to the set of hash tables potentially storing packet classification rules matching the tuple T. For each of the M rule classes for which a lookup in the hash table representation of the rule class resulted in a determination that the hash table potentially includes a packet classification rule matching the tuple T, a lookup is performed in the hash table to determine whether or not the hash table actually includes a packet classification rule matching the tuple T. For example, for the case in which an M-bit array is used to represent the results of the M lookup operations into the hash table representations for identifying hash tables that may potentially have packet classification rules matching the tuple T, the M-bit array is used to identify which of the hash tables to search (e.g., only searching those hash tables corresponding to hash bits of the M-bit array that are set in a manner indicating that the corresponding hash table representation potentially includes a packet classification rule matching the tuple T; not searching those hash tables corresponding to hash bits of the M-bit array that are set in a manner indicating that the corresponding hash table representation does not potentially include a packet classification rule matching the tuple T). For a given hash table associated with a hash table representation indicative that the hash table is potentially storing a packet classification rule matching the tuple T, the hash table may be searched by using a hash of the tuple T as a key into the hash table. If, for a given hash table, a match is found in the hash table, the packet classification rule information for the matching packet classification rule is retrieved from the entry corresponding to the matching packet classification rule. If, for a given hash table, a match is not found in the hash table (e.g., the lookup returns a null value or other value indicative that a match is not found), this is indicative that the match identified in the corresponding hash table representation was a false positive. The set of matching packet classification rules for the tuple T may include zero or more packet classification rules.

At step 399, method 300 ends. It will be appreciated that, although depicted and described as ending (for purposes of clarity), method 300 may be repeated for each tuple of the received packet where the packet includes multiple tuples. The execution of method 300 of FIG. 3 one or more times for the one or more tuples of the packet results in identification of a set of matching packet classification rules for the packet, which may then be handled in any suitable manner (e.g., applying the packet classification rule in the case of identification of a single packet classification rule for the packet, selecting a highest priority packet classification rule and applying the selected highest priority packet classification rule in the case of identification of multiple packet classification rules for the packet, or the like).

It will be appreciated that, while the packet classification functions depicted and described with respect to FIGS. 2 and 3 may be advantageous in various contexts, there may be contexts in which the packet classification functions depicted and described with to FIGS. 2 and 3 may have certain limitations. For example, such limitations may include the need to perform a relatively high number of hash operations, problems associated with false positives, an inability to handle overlapping packet classification rules, an inability to handle more complex rules (e.g., ranges for IP addresses, ranges for port numbers, or the like). With respect to the number of hash operations, it is noted that the packet classification rule lookup process of FIG. 3 requires the computation of k*M hash functions in order to check the M hash table representations during a lookup for a given tuple. As a result, as the value of M increases, the number of hash calculations performed for each tuple lookup increases and additional computational resources of the packet classification element are consumed, which may exhaust the available computational resources of the packet classification element and cause at least a portion of the hash calculations to be serialized (thereby reducing the overall speed of each lookup operation). Accordingly, in at least some embodiments, packet classification element 120 may be configured to support packet classification based on use of hash table representations in a manner that constrains the number of hash calculations performed for each tuple lookup by making the number of hash calculations performed for each tuple lookup independent of the value of M).

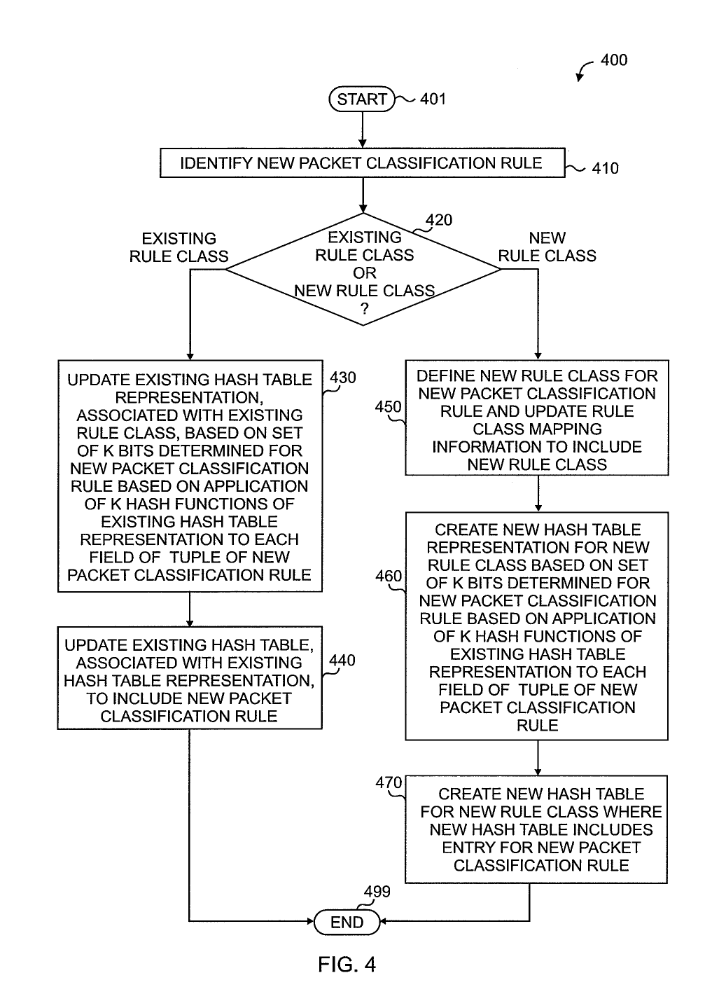

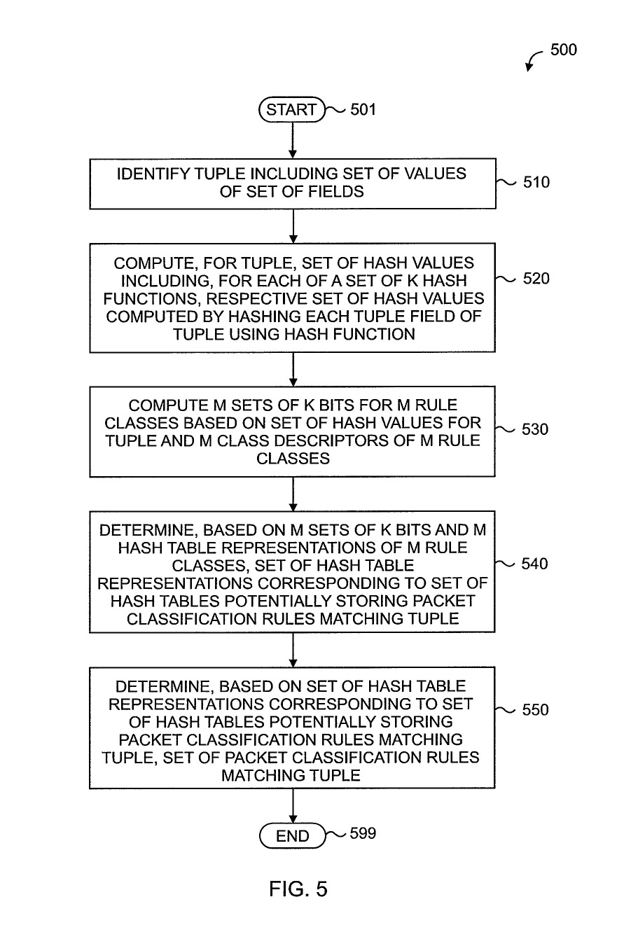

In at least some embodiments, packet classification process 126 is configured to provide packet classification functions based on hashing on individual fields of tuples of a packet received at packet classification element 120. In at least some embodiments, the packet classification process 126 may be configured to (1) perform insertions of new packet classification rules received at packet classification element 120 using the packet classification rule insertion process depicted in FIG. 4 and (2) perform lookups for tuples of packets received at packet classification element 120 using packet classification rule lookup process depicted in FIG. 5. As discussed with respect to the packet classification rule insertion process of FIG. 4 and the packet classification rule lookup process of FIG. 5, hashing on individual fields of a tuple of a packet enables the number of hash calculations performed for a lookup for the tuple to be reduced from M×k hash calculations to d×k hash calculations (where d is the number of fields of the tuple and k is the number of hash functions used).

FIG. 4 depicts one embodiment of a method for performing insertion of a new packet classification rule within the packet classification element of FIG. 1. It will be appreciated that, although primarily depicted and described as being performed serially, at least a portion of the steps of method 400 may be performed contemporaneously or in a different order than presented in FIG. 4.

At step 401, method 400 begins.

At step 410, a new packet classification rule is identified. The new packet classification rule may be identified based on explicit identification of the new packet classification rule, a failure to identify a matching packet classification rule during a packet classification rule lookup operation, or the like.

At step 420, a determination is made as to whether the new packet classification rule corresponds to an existing rule class or whether a new rule class needs to be created for the new packet classification rule. If a determination is made that the new packet classification rule corresponds to an existing rule class, method 400 proceeds to step 430. If a determination is made that a new rule class needs to be created for the new packet classification rule, method 400 proceeds to step 450. This determination as to whether the new packet classification rule corresponds to an existing rule class or whether a new rule class needs to be created for the new packet classification may be performed by (a) determining a descriptor of the new packet classification rule and (b) searching rule class mapping information (illustratively, rule class mapping information 123) to determine whether the descriptor of the new packet classification rule matches an existing class descriptor of an existing rule class. If the descriptor of the new packet classification rule matches an existing class descriptor of an existing rule class, the new packet classification rule is added to the packet classification element 120 as part of the existing rule class. If the descriptor of the new packet classification rule does not match an existing class descriptor of an existing rule class, the new packet classification rule is added to the packet classification element 120 as part of the new rule class created at the packet classification element 120 for the new packet classification rule.

At step 430, an existing hash table representation (illustratively, a hash table representation 124ᵢ) that is associated with the existing rule class is updated to include a representation of the new packet classification rule. The existing hash table representation may be updated by (1) determining a set of k hash bits, associated with k hash functions of the existing hash table representation, for the new packet classification rule and (2) setting the corresponding k hash bits of the hash table representation, based on the determined set of k hash bits for the new packet classification rule, accordingly. The set of k hash bits for the new packet classification rule may be determined by performing the following for each of the k hash functions of the existing hash table representation: (1) applying the hash function to each of the d fields of the tuple of the new packet classification rule to form d hash values for the tuple of the new packet classification rule, (2) concatenating the d hash values for the tuple of the new packet classification rule, and (3) performing a modulo m operation (where m is the size of the existing hash table representation) on the concatenation of the d hash values for the tuple of the new packet classification rule in order to convert the d hash values for the tuple of the new packet classification rule into a single bit associated with the hash function. The determination of the set of k hash bits, associated with the k hash functions of the existing hash table representation, for the new packet classification rule may be represented as:

$$\begin{matrix}{bit}_{1} = ( {H}_{1}^{1} + {H}_{1}^{2} + … {H}_{1}^{d} ) mod m \\ {bit}_{2} = ( {H}_{2}^{1} + {H}_{2}^{2} + … {H}_{2}^{d} ) mod m \\ … \\ {bit}_{k} = ( {H}_{k}^{1} + {H}_{k}^{2} + … {H}_{k}^{d} ) mod m\end{matrix} \qquad$$

where a value Hᵢ^{j} corresponds to a computation of a hash of field j (j=1 . . . d) of the tuple based on hash function i (i=1 . . . k) associated with the existing hash table representation.

At step 440, an existing hash table (illustratively, a hash table 125ᵢ) that is associated with the existing rule class is updated to include the new packet classification rule. The existing hash table may be updated by creating a new entry for the new packet classification rule. The new entry of the existing hash table for the new packet classification rule may include (1) a hash of the tuple of the new packet classification rule as a key into the new entry of the existing hash table and (2) a corresponding value including rule information of the new packet classification rule (e.g., action, priority, or the like, as well as various combinations thereof). From step 440, method 400 proceeds to step 499, where method 400 ends.

At step 450, a new rule class is defined for the new packet classification rule and the rule class mapping information (illustratively, rule class mapping information 123) is updated to include the new rule class.

At step 460, a new hash table representation (illustratively, a new hash table representation 124ᵢ) is created for the new rule class defined for the new packet classification rule. The new hash table representation may be created for the new rule class by (1) determining a set of k hash bits, associated with k hash functions of the new hash table representation, for the new packet classification rule and (2) setting the corresponding k hash bits of the new hash table representation, based on the determined set of k hash bits for the new packet classification rule, accordingly. Here, the set of k hash bits for the new packet classification rule may be determined by calculating each of the k hash bits as discussed above with respect to step 430.

At step 470, a new hash table (illustratively, a new hash table 125ᵢ) is created for the new rule class defined for the new packet classification rule. The new hash table is associated with the new hash table representation. The new hash table for the new rule class may be created by generating the new hash table to include an entry for the new packet classification rule. The entry of the new hash table for the new packet classification rule may include (1) a hash of the tuple of the new packet classification rule as a key into the entry of the new hash table and (2) a corresponding value including rule information of the new packet classification rule (e.g., action, priority, or the like, as well as various combinations thereof). From step 470, method 400 proceeds to step 499, where method 400 ends.

At step 499, method 400 ends.

It will be appreciated that while the number of hash calculations required for an insertion in method 400 of FIG. 4 is an increase over the number of hash calculations required for an insertion in method 200 of FIG. 2, representation of a packet classification rule in a hash table representation in this manner enables the number of hash calculations required during a lookup operation of a tuple of a received packet to be made independent of the number of packet classes M (i.e., to be equal to d×k, rather than M×k).

FIG. 5 depicts one embodiment of a method for performing a lookup for a tuple of a packet at the packet classification element of FIG. 1. The method 500 is configured to perform the lookup for the tuple based on a set of rule classes (illustratively, rule classes as defined in rule class mapping information 123) having respective hash tables (illustratively, hash tables 125) associated therewith, where the hash tables have respective hash table representations (illustratively, hash table representations 124) associated therewith. It will be appreciated that, although primarily depicted and described as being performed serially, at least a portion of the steps of method 500 may be performed contemporaneously or in a different order than presented in FIG. 5.

At step 501, method 500 begins.

At step 510, the tuple (T) of the packet is identified. The tuple T may include a set of values (one or more values) associated with a set of fields (one or more fields) of the tuple T. The set of fields of the tuple T may include one or more wildcarded values.

At step 520, a set of hash values is computed for the tuple T. The set of hash values for the tuple T includes, for each of a set of k hash functions associated with the hash table representations, a respective set of hash values computed by hashing each tuple field of the tuple T using the hash functions. The set of hash values computed for the tuple T may be represented as:

$$\begin{matrix}{H}_{1}^{1} ; {H}_{1}^{2} ; … ; {H}_{1}^{d} \\ {H}_{2}^{1} ; {H}_{2}^{2} ; … ; {H}_{2}^{d} \\ … \\ {H}_{k}^{1} ; {H}_{k}^{2} ; … ; {H}_{k}^{d}\end{matrix}$$

where a value Hᵢ^{j} corresponds to a computation of a hash of field j (j=1 . . . d) of the tuple based on hash function i (i=1 . . . k) associated with the hash table representations. It is noted that the computation of the set of hash values for the tuple T is only computed once and may then be used for evaluating each of the hash table representations for the tuple T as discussed below (thereby making the number of hash calculations performed for evaluating each of the hash table representations for the tuple T independent of the number of hash table representations (i.e., independent of the value of M)).

At step 530, M sets of k hash bits are computed for the M rule classes based on the set of hash values for the tuple T and the M class descriptors of the M rule classes. For a given rule class, the set of k hash bits may be computed by, for each of the k hash functions associated with the hash table representations: (1) masking the set of hash values of the tuple T for the hash function with the class descriptor of the given rule class to determine thereby a set of masked hash values of the tuple T for the hash function, (2) concatenating the set of masked hash values of the tuple T for the hash function to form a concatenation of masked hash values, and (3) performing a modulo m operation (where m is the size of the hash table representations) on the concatenation of the masked hash values of the tuple T for the hash function to convert the set of masked hash values of the tuple T for the hash function into a single bit associated with the hash function. Namely, for a given rule class, the computation of the set of k hash bits for the rule class may be represented by:

$$\begin{matrix}{bit}_{1} = ( {H}_{1}^{1} + {H}_{1}^{2} + … {H}_{1}^{d} ) mod m \\ {bit}_{2} = ( {H}_{2}^{1} + {H}_{2}^{2} + … {H}_{2}^{d} ) mod m \\ … \\ {bit}_{k} = ( {H}_{k}^{1} + {H}_{k}^{2} + … {H}_{k}^{d} ) mod m\end{matrix}$$

wherein it will be appreciated that the masking of the set of hash values of the tuple T for the hash function with the class descriptor of the given rule class will eliminate any of the hash values of the tuple T associated with fields for which the class descriptor includes a wildcard. For example, if the class descriptor of the given rule class includes a wildcard only in the second field, the computation of each of the k hash bits for the rule class will be performed as represented above with the exception that the k concatenations for the k hash bits of the rule class will exclude the Hᵢ² values (i=1 . . . k), respectively. Similarly, for example, if the class descriptor of the given rule class includes wildcards in the fourth and sixth fields, the computation of each of the k hash bits for the rule class will be performed as represented above with the exception that the k concatenations for the k hash bits of the rule class will exclude both the Hᵢ⁴ and Hᵢ⁶ values, respectively. For a given rule class and a given hash function, the masking of the set of hash values of the tuple T for the hash function with the class descriptor of the given rule class to determine thereby the set of masked hash values of the tuple T for the hash function may include performing a field-wise logical AND of the set of masked hash values of the tuple T for the hash function and the set of fields of the class descriptor (e.g., for bit₁ associated with the first hash function, performing a field-wise logical AND of [H₁¹, H₁², . . . H₁^{d}] and the d fields of the class descriptor of the rule class; for bit₂ associated with the first hash function, performing a field-wise logical AND of [H₁¹, H₂², . . . H₂^{d}] and the d fields of the class descriptor of the rule class; and so forth for each of the k hash bits associated with each of the k hash functions). It will be appreciated that, in the absence of wildcards, masking of the set of hash values of the tuple T for the hash function with the class descriptor of the given rule class may be omitted, such that the set of k hash bits for the k hash functions associated with the hash table representation may be computed by, for each of the k hash functions, concatenating the set of hash values of the tuple T for the hash function to form a concatenation of hash values performing a modulo m operation (where m is the size of the hash table representations) on the concatenation of the hash values of the tuple T for the hash function to convert the set of hash values of the tuple T for the hash function into a single bit associated with the hash function.

At step 540, a set of hash table representations corresponding to a set of hash tables potentially storing packet classification rules matching the tuple T is determined. For each of the M rule classes, a determination is made as to whether the tuple of the packet potentially matches a packet classification rule of the hash table associated with the rule class. For each of the M rule classes, the set of k hash bits computed for a given rule class is used as a key into the hash table representation of the given rule class. If a match is found in a hash table representation, this is indicative that the associated hash table corresponding to the hash table representation may include a packet classification rule matching tuple T (or may not, given that the hash table representations may suffer from false positives). If a match is not found in a hash table representation, this is indicative that the associated hash table corresponding to the hash table representation does not include a packet classification rule matching tuple T (as there are no false negatives). The results of these M lookup operations may be represented in any suitable format. For example, the results of these M lookup operations may be represented as an M-bit array where the M bit positions of the M-bit array correspond to the M rule classes, and where a given bit position of the M-bit array is set to a first value (e.g., “1”) based on a determination that the set of hash values resulted in identification of a match in the corresponding hash table representation (and, thus, that the associated hash table corresponding to the hash table representation potentially includes a packet classification rule matching tuple T) or set to a second value (e.g., “0”) based on a determination that the set of hash values did not result in identification of a match in the corresponding hash table representation (and, thus, that the associated hash table corresponding to the hash table representation does not include a packet classification rule matching tuple T). The results of the M determinations performed for the M rule classes based on the M sets of k hash bits may be represented in any other suitable manner.

At step 550, a set of matching packet classification rules is determined for the tuple T based on the set of hash table representations corresponding to the set of hash tables potentially storing packet classification rules matching the tuple T. For each of the M rule classes for which a lookup in the hash table representation of the rule class resulted in a determination that the hash table potentially includes a packet classification rule matching the tuple T, a lookup is performed in the hash table to determine whether or not the hash table actually includes a packet classification rule matching the tuple T. For example, for the case in which an M-bit array is used to represent the results of the M lookup operations into the hash table representations for identifying hash tables that may potentially have packet classification rules matching the tuple T, the M-bit array is used to identify which of the hash tables to search (e.g., only searching those hash tables corresponding to hash bits of the M-bit array that are set in a manner indicating that the corresponding hash table representation potentially includes a packet classification rule matching the tuple T; not searching those hash tables corresponding to hash bits of the M-bit array that are set in a manner indicating that the corresponding hash table representation does not potentially include a packet classification rule matching the tuple T). For a given hash table associated with a hash table representation indicative that the hash table is potentially storing a packet classification rule matching the tuple T, the hash table may be searched by using a hash of the tuple T as a key into the hash table. If, for a given hash table, a match is found in the hash table, the packet classification rule information for the matching packet classification rule is retrieved from the entry corresponding to the matching packet classification rule. If, for a given hash table, a match is not found in the hash table (e.g., the lookup returns a null value or other value indicative that a match is not found), this is indicative that the match identified in the corresponding hash table representation was a false positive. The set of matching packet classification rules for the tuple T may include zero or more packet classification rules.

At step 599, method 500 ends. It will be appreciated that, although depicted and described as ending (for purposes of clarity), method 500 may be repeated for each tuple of the received packet where the packet includes multiple tuples. The execution of method 500 of FIG. 5 one or more times for the one or more tuples of the packet results in identification of a set of matching packet classification rules for the packet, which may then be handled in any suitable manner (e.g., applying the packet classification rule in the case of identification of a single packet classification rule for the packet, selecting a highest priority packet classification rule and applying the selected highest priority packet classification rule in the case of identification of multiple packet classification rules for the packet, or the like).

It will be appreciated that, while the number of AND operations performed for lookup of a tuple in method 500 of FIG. 5 is an increase over the number AND operations performed for a lookup of a tuple in method 300 of FIG. 3, the number of hash calculations is reduced to d×k hash calculations (in method 500 of FIG. 5) from M×k hash calculations (in method 300 of FIG. 3). Thus, although there is a tradeoff in the form of an increase in the number of AND operations, AND operations typically are orders of magnitude less complex than hash operations (e.g., since a hash operation typically includes at least one AND operation) and, therefore, the overall computational efficiency of a lookup operation is increased and the overall complexity of a lookup operation is reduced when using method 500 of FIG. 5 rather than method 300 of FIG. 3.

It will be appreciated that, although the extend of improvement of the method 500 of FIG. 5 over the method 300 of FIG. 3 is expected to increase with increases in the value of M (i.e., the number of rule classes into which the packet classification rules are partitioned), the principles of method 500 of FIG. 5 may be applied for performing packet classification for any value of M>0. It will be further appreciated that, in the case of M=1, method 500 of FIG. 5 may be simplified to include steps of (1) receiving a tuple including a set of tuple fields having a respective set of data values associated therewith, (2) computing, for each hash function in a set of hash functions, a respective set of hash values for the tuple by hashing each of the data values of the tuple using the respective hash function, (3) computing a set of hash bits for the tuple based on the respective sets of hash values for the tuple, and (4) determining whether a hash table potentially includes a match for the data set by checking a hash table representation of the hash table based on the set of hash bits for the data set. It will be further appreciated that, in the case of M>1 (e.g., where the number of rule classes is or increases to be greater than one), lookups for the tuple in the multiple hash tables of the multiple rule classes may be performed by only repeating step (4) above for each of the multiple rule classes (namely, determining whether the respective hash table of the respective rule class potentially includes a match for the data set by checking a respective hash table representation of the respective hash table based on the set of hash bits for the data set), such that steps (1)-(3) do not need to be repeated as long as the same set of hash functions is used for each of the rule classes.

FIG. 6 depicts an exemplary set of packet classification rules for illustrating relationships between the packet classification rules and rule classes, hash table representations, and hash tables of the packet classification element of FIG. 1. For example, a first packet classification rule (denoted as “a”) is associated with a first rule class (denoted as Class 1) and, therefore: (1) the first packet classification rule is stored in an entry of a first hash table (denoted as Hash Table 1) storing packet classification rules for the first rule class and (2) an indication of storage of the first packet classification rule in the first hash table is represented in a first Bloom filter (denoted as Bloom Filter 1), associated with the first rule class and the first hash table, based on k hash functions (denoted as H₁ . . . Hₖ). Similarly, for example, a second packet classification rule (denoted as “b”) also is associated with the first rule class and, therefore: (1) the second packet classification rule is stored in a second entry of the first hash table storing packet classification rules for the first rule class and (2) an indication of storage of the second packet classification rule in the first hash table is represented in the first Bloom filter, associated with the first rule class and the first hash table, based on the k hash functions (denoted as H₁ . . . Hₖ). Similarly, for example, a third packet classification rule (denoted as “c”) is associated with a second rule class (denoted as Class 2) and, therefore: (1) the third packet classification rule is stored in an entry of a second hash table (denoted as Hash Table 2) storing packet classification rules for the second rule class and (2) an indication of storage of the third packet classification rule in the second hash table is represented in a second Bloom filter (denoted as Bloom Filter 2), associated with the second rule class and the second hash table, based on k hash functions (denoted as H₁ . . . Hₖ).

It will be appreciated that, although primarily depicted and described herein with respect to performing packet classification based on a set of packet classification rules, various embodiments depicted and described herein may be used for performing various other types of operations based on various other types of rules (e.g., performing IP address lookups based on a set of IP address lookup rules, performing flow lookups based on a set of flow lookup rules, or the like). More generally, various embodiments depicted and described herein may be used for performing data classification or matching based on a set of data classification or matching rules. Accordingly, in at least some embodiments, references herein to packet classification and packet classification rules may be read more generally as data classification (or, more simply, classification) and data classification rules (or, more simply, rules), respectively. More generally, various embodiments depicted and described herein may be used for providing a data matching capability that is configured to support matching of a set of values of a set of data fields to a corresponding set of values of a corresponding set of data fields. The data matching capability may be configured to support matching of a set of values of a set of data fields to a corresponding set of values of a corresponding set of data fields based on use of the set of values of the set of data fields as an input and based on a hash table representation of a hash table storing the corresponding set of values of the corresponding set of data fields. As previously indicated, the data matching capability may be used within various contexts including, but not limited to, applied statistics, data management, data mining, machine learning, artificial intelligence, database management, healthcare applications, communication applications, or any other suitable environments or applications for data matching, as well as various combinations thereof. In at least some embodiments, the data matching capability may be adapted for use in deoxyribonucleic acid (DNA) sequence mapping, genome sequence mapping, or other suitable types of sequence mapping. Accordingly, in at least some embodiments, references herein to data classification and data classification rules may be read more generally as being reference to data matching, data lookup, or the like. Additionally, various references herein to typically packet-specific terms (e.g., tuple and the like) also may be read more generally as being data sets (e.g., a set of values of a set of data fields being a data set, or the like). Additionally, various other modifications or generalizations of terms used herein, for embodiments provided within contexts other than performing packet classification within communication networks, will be understood from the other contexts within which embodiments of the data matching capability may be provided (e.g., applied statistics, data management, data mining, DNA sequence mapping, and so forth, as discussed above).

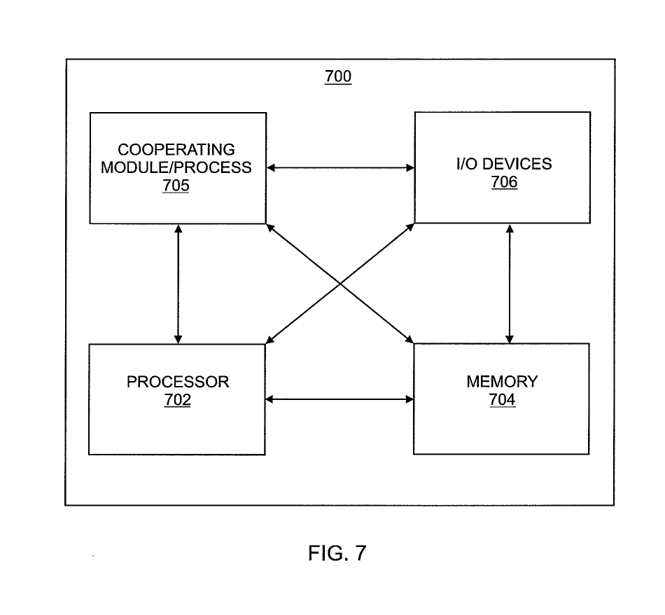

FIG. 7 depicts a high-level block diagram of a computer suitable for use in performing functions described herein.

The computer 700 includes a processor 702 (e.g., a central processing unit (CPU) and/or other suitable processor(s)) and a memory 704 (e.g., random access memory (RAM), read only memory (ROM), and the like).

The computer 700 also may include a cooperating module/process 705. The cooperating process 705 can be loaded into memory 704 and executed by the processor 702 to implement functions as discussed herein and, thus, cooperating process 705 (including associated data structures) can be stored on a computer readable storage medium, e.g., RAM memory, magnetic or optical drive or diskette, and the like.

The computer 700 also may include one or more input/output devices 706 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 700 depicted in FIG. 7 provides a general architecture and functionality suitable for implementing functional elements described herein and/or portions of functional elements described herein. For example, computer 700 provides a general architecture and functionality suitable for implementing one or more of packet classification element 120, a portion of packet classification element 120, or the like. For example, computer 700 provides a general architecture and functionality suitable for implementing other elements which may be used for supporting data matching within other types of contexts, as discussed above.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), and/or any other hardware equivalents).

It will be appreciated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

It will be appreciated that the term “or” as used herein refers to a non-exclusive “or,” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus configured to match data using a set of hash functions, comprising:
a processor and a memory communicatively connected to the processor, the processor configured to:
receive a data set including a set of data fields having a respective set of data values associated therewith;
compute, for each of the hash functions, a respective set of hash values for the data set by hashing each of the data values of the data set using the respective hash function;
compute a set of hash bits for the data set based on the respective sets of hash values for the data set; and
determine whether a hash table potentially includes a match for the data set by checking a hash table representation of the hash table based on the set of hash bits for the data set.

2. The apparatus of claim 1, wherein, to compute the set of hash bits for the data set based on the respective sets of hash values for the data set, the processor is configured to:
for each set of hash values, compute the respective hash bit of the set of hash bits based on a concatenation of the hash values of the set of hash values.

3. The apparatus of claim 2, wherein, to compute the respective hash bit of the set of hash bits based on the concatenation of the hash values of the set of hash values, the processor is configured to:
concatenate the hash values of the set of hash values to form a concatenation of the hash values; and
compute the respective hash bit for the set of hash values by performing a modulo m operation on the concatenation of the hash values, wherein m comprises a size of the hash table representation.

4. The apparatus of claim 1, wherein, to compute the set of hash bits for the data set based on the respective sets of hash values for the data set, the processor is configured to:
for each set of hash values, mask a descriptor of a class associated with the hash table with the set of hash values to form a respective set of masked hash values associated with the respective hash values of the set of hash values; and
for each set of masked hash values, compute the respective hash bit of the set of hash bits for the set of hash values based on a concatenation of the masked hash values of the set of masked hash values.

5. The apparatus of claim 4, wherein the descriptor comprises a set of descriptor fields, wherein, to mask the descriptor of the class associated with the hash table with the set of hash values to form the set of masked hash values, the processor is configured to:
for each of the descriptor fields of the descriptor, perform a logical AND between the descriptor field of the descriptor and a corresponding one of the hash values associated with the descriptor field of the descriptor.

6. The apparatus of claim 4, wherein, to compute the respective hash bit of the set of hash bits based on a concatenation of the masked hash values of the set of masked hash values, the processor is configured to:
concatenate the masked hash values of the set of masked hash values to form a concatenation of the masked hash values; and
compute the respective hash bit for the set of hash values by performing a modulo m operation on the concatenation of the masked hash values, wherein m comprises a size of the hash table representation.

7. The apparatus of claim 1, wherein, to compute the set of hash bits for the data set based on the respective sets of hash values for the data set, the processor is configured to:
for each set of hash values:
concatenate the hash values of the set of hash values to form a concatenation of the hash values; and
compute the respective hash bit for the set of hash values by performing a modulo m operation on the concatenation of the hash values, wherein m comprises a size of the hash table representation.

8. The apparatus of claim 1, wherein the processor is configured to:
based on a determination that the set of hash bits matches the hash table representation, search the hash table for an entry matching the data set.

9. The apparatus of claim 1, wherein the hash table is a first hash table associated with a first data class, the processor further configured to:
determine whether a second hash table associated with a second data class potentially includes a match for the data set by checking a second hash table representation of the second hash table based on the set of hash bits for the data set.

10. The apparatus of claim 1, wherein the data set comprises a tuple of a packet, wherein the hash table is configured to store a set of packet classification rules.

11. A method for matching data using a set of hash functions, the method comprising:
using a processor and a memory for:
receiving a data set including a set of data fields having a respective set of data values associated therewith;
computing, for each of the hash functions, a respective set of hash values for the data set by hashing each of the data values of the data set using the respective hash function;
computing a set of hash bits for the data set based on the respective sets of hash values for the data set; and
determining whether a hash table potentially includes a match for the data set by checking a hash table representation of the hash table based on the set of hash bits for the data set.

12. The method of claim 11, wherein computing the set of hash bits for the data set based on the respective sets of hash values for the data set comprises:
for each set of hash values, computing the respective hash bit of the set of hash bits based on a concatenation of the hash values of the set of hash values.

13. The method of claim 12, wherein computing the respective hash bit of the set of hash bits based on the concatenation of the hash values of the set of hash values comprises:
concatenating the hash values of the set of hash values to form a concatenation of the hash values; and
computing the respective hash bit for the set of hash values by performing a modulo m operation on the concatenation of the hash values, wherein m comprises a size of the hash table representation.

14. The method of claim 11, wherein computing the set of hash bits for the data set based on the respective sets of hash values for the data set comprises:
for each set of hash values, masking a descriptor of a class associated with the hash table with the set of hash values to form a respective set of masked hash values associated with the respective hash values of the set of hash values; and
for each set of masked hash values, computing the respective hash bit of the set of hash bits for the set of hash values based on a concatenation of the masked hash values of the set of masked hash values.

15. The method of claim 14, wherein the descriptor comprises a set of descriptor fields, wherein masking the descriptor of the class associated with the hash table with the set of hash values to form the set of masked hash values comprises:
for each of the descriptor fields of the descriptor, performing a logical AND between the descriptor field of the descriptor and a corresponding one of the hash values associated with the descriptor field of the descriptor.

16. The method of claim 14, wherein computing the respective hash bit of the set of hash bits based on a concatenation of the masked hash values of the set of masked hash values comprises:
concatenating the masked hash values of the set of masked hash values to form a concatenation of the masked hash values; and
computing the respective hash bit for the set of hash values by performing a modulo m operation on the concatenation of the masked hash values, wherein m comprises a size of the hash table representation.

17. The method of claim 11, wherein computing the set of hash bits for the data set based on the respective sets of hash values for the data set comprises:
for each set of hash values:
concatenating the hash values of the set of hash values to form a concatenation of the hash values; and
computing the respective hash bit for the set of hash values by performing a modulo m operation on the concatenation of the hash values, wherein m comprises a size of the hash table representation.

18. The method of claim 11, further comprising:
based on a determination that the set of hash bits matches the hash table representation, searching the hash table for an entry matching the data set.

19. The method of claim 11, wherein the hash table is a first hash table associated with a first data class, the method further comprising:
determining whether a second hash table associated with a second data class potentially includes a match for the data set by checking a second hash table representation of the second hash table based on the set of hash bits for the data set.

20. The method of claim 11, wherein the data set comprises a tuple of a packet, wherein the hash table is configured to store a set of packet classification rules.

21. A computer-readable storage medium storing instructions which, when executed by a computer, cause the computer to perform a method, the method comprising:
receiving a data set including a set of data fields having a respective set of data values associated therewith;
computing, for each of the hash functions, a respective set of hash values for the data set by hashing each of the data values of the data set using the respective hash function;
computing a set of hash bits for the data set based on the respective sets of hash values for the data set; and
determining whether a hash table potentially includes a match for the data set by checking a hash table representation of the hash table based on the set of hash bits for the data set.

22. An apparatus configured to classify data using a set of data classification rules and a set of hash functions, comprising:
a processor and a memory communicatively connected to the processor, the processor configured to:
receive a tuple comprising a set of tuple fields having a respective set of data values associated therewith;
mask the set of data values of the set of tuple fields of the tuple to form a masked tuple;
compute a set of hash values for the tuple based on hashing of the masked tuple using the respective hash functions; and
determine whether a hash table potentially includes a data classification rule matching the tuple by checking a hash table representation of the hash table based on the set of hash values for the tuple.
